(19) United States
(12) Patent Application Publication
(10) Pub. No.: US 2017/0327930 A1
(43) Pub. Date: Nov. 16, 2017

(54) ALUMINUM ALLOY SUBSTRATE FOR MAGNETIC DISK

(71) Applicants: UACJ CORPORATION, Tokyo (JP); FURUKAWA ELECTRIC CO., LTD., Todyo (JP)

(72) Inventors: Kotaro Kitawaki, Tokyo (JP); Akira Hibino, Tokyo (JP); Wataru Kumagai, Tokyo (JP); Mitsuo Masuda, Tokyo (JP); Sadayuki Toda, Tokyo (JP)

(73) Assignees: UACJ Corporation, Tokyo (JP); Furukawa Electric Co., Ltd., Tokyo (JP)

(21) Appl. No.: 15/522,921

(22) PCT Filed: Oct. 30, 2015
(86) PCT No.: PCT/JP2015/080756

§ 371 Date: Apr. 28, 2017

(30) Foreign Application Priority Data
Oct. 31, 2014 (JP) 2014-223387

(51) Int. Cl. C22C 21/02; G11B 5/73; C22C 21/06; C22F 1/043

(52) U.S. Cl. CPC C22C 21/02; G11B 5/73; C22C 21/06; C22F 1/043

(57) ABSTRACT

An aluminum alloy substrate for a magnetic disk includes 0.5 mass % or more and 24.0 mass % or less of Si, 0.01 mass % or more and 3.00 mass % or less of Fe, and the balance of Al and unavoidable impurities. The aluminum alloy substrate for a magnetic disk includes a smooth plated surface and has high rigidity.

### TECHNICAL FIELD

The present disclosure relates to an aluminum alloy substrate for a magnetic disk.

### BACKGROUND ART

Magnetic disks made of aluminum alloys, used in storage devices for computers, are produced with aluminum alloy substrates according to JIS 5086 (3.5 mass % or more and 4.5 mass % or less of Mg, 0.50 mass % or less of Fe, 0.40 mass % or less of Si, 0.20 mass % or more and 0.70 mass % or less of Mn, 0.05 mass % or more and 0.25 mass % or less of Cr, 0.10 mass % or less of Cu, 0.15 mass % or less of Ti, 0.25 mass % or less of Zn, and the balance of Al and unavoidable impurities) which have favorable plating properties and which are excellent in mechanical properties and workability. Further, the magnetic disks made of aluminum alloys are produced with aluminum alloy substrates in which the contents of Fe, Si, and the like which are impurities in JIS 5086 are restricted to reduce the sizes of intermetallic compounds in a matrix for the purpose of improving pit defects due to falling-out of intermetallic compounds in a plating pretreatment step or with aluminum alloy substrates to which Cu and/or Zn in JIS 5086 are intentionally added for the purpose of improving plating properties.

Common magnetic disks made of aluminum alloys are produced by first producing an annular aluminum alloy substrate, plating the aluminum alloy substrate, and then depositing a magnetic substance on a surface of the aluminum alloy substrate.

For example, a magnetic disk made of an aluminum alloy according to the JIS 5086 alloy is produced by the following production steps. First, an aluminum alloy allowed to contain desired chemical components is cast to obtain an ingot, and the ingot is subjected to hot rolling and then to cold rolling to produce a rolled material having a thickness required for the magnetic disks. It is preferable to anneal the rolled material during the cold rolling and/or the like as needed. Then, the rolled material is stamped to have an annular shape. In order to eliminate distortion and/or the like occurring in the production steps, an aluminum alloy sheet allowed to have an annular shape is layered thereon, and the resultant is subjected to pressurization annealing in which the resultant is flattened by annealing the resultant while pressurizing both surfaces of the resultant. As a result, an annular aluminum alloy substrate is produced.

The annular aluminum alloy substrate produced in such a manner is subjected to cutting work, grinding work, degreasing, etching, and zincate treatment (Zn substitution treatment) as pretreatment and then to electroless plating with Ni—P which is a rigid non-magnetic metal as undercoat treatment. The plated surface is subjected to polishing, followed by sputtering a magnetic substance. As a result, the magnetic disk made of an aluminum alloy is produced.

In recent years, larger-capacity and higher-density magnetic disks have been demanded due to the needs of multimedia and the like. The higher capacity has resulted in an increase in the number of magnetic disks placed in a storage device. Thus, thinned magnetic disks have also been demanded.

However, the thinning of an aluminum alloy substrate for a magnetic disk results in decreased rigidity and therefore causes a problem that a magnetic head and a magnetic disk collide with each other (head crash). This is because high-speed rotation of a magnetic disk results in generation of airflow, the airflow causes vibrations (fluttering) of the magnetic disk, and in the case of the low rigidity of a substrate, the vibrations of the magnetic disk are increased, whereby the head is incapable of following variations in the vibrations. When the head crash occurs, recesses and projections or flaws may be generated on a surface of the magnetic disk, thereby causing a record error. Therefore, the higher rigidity of aluminum alloy substrates has been demanded.

In addition, the higher density of a magnetic disk results in a minuter magnetic region per bit and therefore causes an error during reading data even if fine pits (pores) are present on the plated surface of the magnetic disk. Therefore, it is demanded that the plated surface of the magnetic disk has high smoothness with few pits.

In light of such actual circumstances, aluminum alloy substrates for magnetic disks with a smooth plated surface and high rigidity have been earnestly desired and examined in recent years. For example, Patent Literature 1 describes a method in which Mn and Zr are added to an Al—Mg-based alloy to increase the recrystallization temperature of an aluminum alloy substrate and to suppress recrystallization, whereby strength is increased, and fine recesses and projections are prevented from being generated when a magnetic head and a magnetic disk collide with each other.

### CITATION LIST

### Patent Literature

Patent Literature 1: Unexamined Japanese Patent Application Kokai Publication No. H10-273749

### SUMMARY OF INVENTION

### Technical Problem

In the method disclosed in Patent Literature 1, however, contact between the magnetic head and the magnetic disk unavoidably occurs, whereby ultrafine recesses and projections or flaws on a surface are unable to be reduced, due to low rigidity, although higher strength can be achieved. In addition, an aluminum alloy substrate contains a large amount of Mn, a large amount of a coarse compound therefore exists in the aluminum alloy substrate, the compound falls off in a plating pretreatment step, thereby generating large recesses on a surface and generating a large number of pits on the plated surface, and therefore, the desired excellent smoothness of the plated surface is not obtained.

The present disclosure has been made under such actual circumstances with an objective to provide an aluminum alloy substrate for a magnetic disk, with a smooth plated surface and high rigidity.

### Solution to Problem

An aluminum alloy substrate for a magnetic disk of the present disclosure includes:

0.5 mass % or more and 24.0 mass % or less of Si;

0.01 mass or more and 3.00 mass % or less of Fe; and

the balance of Al and unavoidable impurities.

The aluminum alloy substrate for a magnetic disk may further include one or more elements selected from the group consisting of:

0.005 mass % or more and 2.000 mass % or less of Cu;

0.1 mass % or more and 6.0 mass % or less of Mg;

0.1 mass % or more and 2.0 mass % or less of Ni;

0.01 mass % or more and 2.00 mass % or less of Cr,

0.01 mass % or more and 2.00 mass %/o or less of Mn;

0.001 mass % or more and 0.100 mass % or less of Na;

0.001 mass % or more and 0.100 mass % or less of Sr; and

0.001 mass % or more and 0.100 mass % or less of P.

The aluminum alloy substrate for a magnetic disk may further include:

0.005 mass % or more and 2.000 mass % or less of Zn.

The aluminum alloy substrate for a magnetic disk may further include:

Ti and B of which the total of the contents is 0.005 mass % or more and 0.500 mass % or less.

In the aluminum alloy substrate for a magnetic disk,

second phase particles having a longest diameter of 3 μm or more and 100 μm or less may be dispersed at a distribution density of 100 particles/mm² or more and 50000 particles/mm² or less.

The aluminum alloy substrate for a magnetic disk includes second phase particles,

wherein the second phase particles may have a longest diameter of 100 μm or less.

In the aluminum alloy substrate for a magnetic disk,

both surfaces may be cladded with a sheath material including pure Al or an Al—Mg-based alloy.

### Advantageous Effects of Invention

In accordance with the present disclosure, there can be provided an aluminum alloy substrate for a magnetic disk, with a smooth plated surface and high rigidity.

### BRIEF DESCRIPTION OF DRAWINGS

FIG. 1 is a view illustrating the flow of a method for producing a magnetic disk, including a method for producing an aluminum alloy substrate for a magnetic disk, which is a bare material, according to an embodiment of the present disclosure; and

FIG. 2 is a view illustrating the flow of a method for producing a magnetic disk, including a method for producing an aluminum alloy substrate for a magnetic disk, which is a clad material, according to an embodiment of the present disclosure.

### DESCRIPTION OF EMBODIMENTS

The present inventors focused on the rigidity of an aluminum alloy substrate and the smoothness of a plated surface and intensively researched the relationships between such properties and the components and structure of the aluminum alloy substrate. As a result, the contents of Si and Fe in the aluminum alloy substrate were found to greatly influence the rigidity and the smoothness of the plated surface. In addition, the size and distribution density of second phase particles (Si particles, Al—Fe—Si-based compound, or the like) were also found to greatly influence the rigidity and the smoothness of the plated surface. The present inventors have accomplished the present disclosure on the basis of such findings.

An aluminum alloy substrate for a magnetic disk according to an embodiment of the present disclosure will be described in detail below.

The aluminum alloy substrate for a magnetic disk is used as a single-layered bare material or a three-layered clad material. The clad material is an alloy sheet in which two or more different alloy sheets are metallurgically joined. Herein, the intermediate material of the three-layered clad material is regarded as a core material, and materials on both surfaces of the core material are regarded as sheath materials. In addition, the aluminum alloy substrate includes both the bare material and the clad material unless otherwise specified.

Aluminum alloy components in the bare material and the core material of the clad material, included in the Al—Si—Fe-based aluminum alloy substrate for a magnetic disk according to the embodiment of the present disclosure, as well as the contents thereof will be described below.

(Silicon)

Si exists principally as Si particles and has the effect of improving the rigidity of the aluminum alloy substrate. When the content of Si in the aluminum alloy is less than 0.5 mass %, the rigidity of the aluminum alloy becomes insufficient. In contrast, when the content of Si in the aluminum alloy is more than 24.0 mass %, coarse Si particles are generated. In the case of the bare material, the Si particles fall off, thereby generating large recesses, in etching, zincate treatment, and cutting or grinding work, and the smoothness of a plated surface is deteriorated. In the case of the core material of the clad material, the coarse Si particles existing on a side of the substrate fall off in etching, zincate treatment, and cutting, thereby generating large recesses on the side of the substrate. In particular, the generation of the large recesses in the boundary between the core material and the sheath material on the side of the substrate results in the deterioration of adhesiveness between the plating and the substrate and in peeling of the plating. Therefore, the content of Si in the aluminum alloy is set in a range of 0.5 mass % or more and 24.0 mass % or less. In addition, the content of Si is preferably in a range of 1.0 mass % or more and 18.0 mass % or less in view of a trade-off between rigidity and rollability. Still more preferably, the content is in a range of 1.5 mass % or more and 13.0 mass % or less.

(Iron)

Fe exists principally as an Al—Fe—Si-based compound and has the effect of improving the rigidity of the aluminum alloy substrate. When the content of Fe in the aluminum alloy is less than 0.01 mass %, rigidity becomes insufficient. In contrast, when the content of Fe in the aluminum alloy is more than 3.00%, a coarse Al—Fe—Si-based compound is generated. In the case of the bare material, the Al—Fe—Si-based compound falls off in etching, zincate treatment, and cutting or grinding work, thereby generating large recesses, and the smoothness of the plated surface is deteriorated. In the case of the core material of the clad material, the coarse Al—Fe—Si-based compound existing on the side of the substrate falls off in etching, zincate treatment, and cutting, thereby generating large recesses on the side of the substrate. In particular, the generation of the large recesses in the boundary between the core material and the sheath material on the side of the substrate side results in the deterioration of adhesiveness between the plating and the substrate and in peeling of the plating. Therefore, the content of Fe in the aluminum alloy is set in a range of 0.05 mass % or more and 3.00 mass % or less. In addition, the content of Fe is preferably in a range of 0.10 mass % or more and 3.00 mass % or less.

In the aluminum alloy substrate for a magnetic disk, an aluminum alloy further selectively containing one or more elements selected from the group consisting of preferably 0.005 mass % or more and 2.000 mass % or less of Cu, preferably 0.1 mass % or more and 6.0 mass % or less of Mg, preferably 0.1 mass % or more and 2.0 mass % or less of Ni, preferably 0.01 mass % or more and 2.00 mass % or less of Cr, preferably 0.01 mass % or more and 2.00 mass % or less of Mn, preferably 0.001 mass % or more and 0.100 mass % or less of Na, preferably 0.001 mass % or more and 0.100 mass % or less of Sr, preferably 0.001 mass % or more and 0.100 mass % or less of P, and Ti and B of which the total of the contents is preferably 0.005 mass % or more and 0.500 mass % or less, in addition to Si and Fe described above, can also be used in order to further improve the rigidity of the aluminum alloy substrate. The selected elements will be described below.

(Copper)

Cu exists principally as an Al—Cu-based compound and has the effect of improving the rigidity of the aluminum alloy substrate. In addition, Cu also has the effect of reducing the amount of Al melted in zincate treatment and uniformly, thinly, and minutely depositing a zincate coating film to improve the smoothness of plating in a subsequent step. The effect of improving the rigidity and the effect of improving the smoothness can be further obtained by setting the content of Cu in the aluminum alloy at 0.005 mass % or more. In addition, generation of a coarse Al—Cu-based compound is suppressed by setting the content of Cu in the aluminum alloy at 2.000 mass %/o or less. In the case of the bare material, there can be further obtained the effect of suppressing falling-off of the Al—Cu-based compound and generation of large recesses in etching, zincate treatment, and cutting or grinding work and of improving the smoothness of the plated surface. In the case of the core material of the clad material, the falling-off of the coarse Al—Cu-based compound on the side of the substrate and the generation of large recesses in etching, zincate treatment, and cutting can be suppressed, and the peeling of plating in the boundary between the core material and the sheath material on the side of the substrate can be further suppressed. Therefore, the content of Cu in the aluminum alloy is preferably in a range of 0.005 mass % or more and 2.000 mass % or less and more preferably in a range of 0.010 mass %/o or more and less than 2.000 mass %.

(Magnesium)

Mg principally exists as a Mg—Si-based compound and has the effect of improving the rigidity of the aluminum alloy substrate. The effect of improving the rigidity can be further obtained by setting the content of Mg in the aluminum alloy at 0.1 mass % or more. In addition, generation of a coarse Mg—Si-based compound is suppressed by setting the content of Mg in the aluminum alloy at 6.0 mass % or less. In the case of the bare material, the falling-off of the Mg—Si-based compound and the generation of large recesses in etching, zincate treatment, and cutting or grinding work can be suppressed, and the deterioration of the smoothness of the plated surface can be further suppressed. In the case of the core material of the clad material, the falling-off of the coarse Mg—Si-based compound on the side of the substrate and the generation of large recesses in etching, zincate treatment, and cutting can be suppressed, and the peeling of plating in the boundary between the core material and the sheath material on the side of the substrate can be further suppressed. Therefore, the content of Mg in the aluminum alloy is preferably in a range of 0.1 mass % or more and 6.0 mass % or less and more preferably in a range of 0.3 mass % or more and less than 1.0 mass %.

(Nickel)

Ni exists principally as an Al—Ni-based compound and has the effect of improving the rigidity of the aluminum alloy substrate. The effect of improving the rigidity can be further obtained by setting the content of Ni in the aluminum alloy at 0.1 mass % or more. In addition, generation of a coarse Al—Ni-based compound is suppressed by setting the content of Ni in the aluminum alloy at 2.0 mass % or less. In the case of the bare material, the falling-off of the Al—Ni-based compound and the generation of large recesses in etching, zincate treatment, and cutting or grinding work can be suppressed, and the deterioration of the smoothness of the plated surface can be further suppressed. In the case of the core material of the clad material, the falling-off of the coarse Al—Ni-based compound on the side of the substrate and the generation of large recesses in etching, zincate treatment, and cutting can be suppressed, and the peeling of plating in the boundary between the core material and the sheath material on the side of the substrate can be further suppressed. Therefore, the content of Ni in the aluminum alloy is preferably in a range of 0.1 mass % or more and 2.0 mass % or less and more preferably in a range of 0.3 mass % or more and less than 2.0 mass %.

(Chromium)

Cr exists principally as an Al—Cr-based compound and has the effect of improving the rigidity of the aluminum alloy substrate. The effect of improving the rigidity can be further obtained by setting the content of Cr in the aluminum alloy at 0.01 mass % or more. In addition, generation of a coarse Al—Cr-based compound is suppressed by setting the content of Cr in the aluminum alloy at 2.00 mass % or less. In the case of the bare material, the falling-off of the Al—Cr-based compound and the generation of large recesses in etching, zincate treatment, and cutting or grinding work can be suppressed, and the deterioration of the smoothness of the plated surface can be further suppressed. In the case of the core material of the clad material, the falling-off of the coarse Al—Cr-based compound on the side of the substrate and the generation of large recesses in etching, zincate treatment, and cutting can be suppressed, and the peeling of plating in the boundary between the core material and the sheath material on the side of the substrate can be further suppressed. Therefore, the content of Cr in the aluminum alloy is preferably in a range of 0.01 mass % or more and 2.00 mass % or less and more preferably in a range of 0.1 mass % or more and less than 2.0 mass %.

(Manganese)

Mn exists principally as an Al—Mn—Si-based compound and has the effect of improving the rigidity of the aluminum alloy substrate. The effect of improving the rigidity can be further obtained by setting the content of Mn in the aluminum alloy at 0.01 mass % or more. In addition, generation of a coarse Al—Mn—Si-based compound is suppressed by setting the content of Mn in the aluminum alloy at 2.00 mass % or less. In the case of the bare material, the falling-off of the Al—Mn—Si-based compound and the generation of large recesses in etching, zincate treatment, and cutting or grinding work can be suppressed, and the deterioration of the smoothness of the plated surface can be further suppressed. In the case of the core material of the clad material, the falling-off of the coarse Al—Mn—Si-based compound on the side of the substrate and the generation of large recesses in etching, zincate treatment, and cutting can be suppressed, and the peeling of plating in the boundary between the core material and the sheath material on the side of the substrate can be further suppressed. Therefore, the content of Mn in the aluminum alloy is preferably in a range of 0.01 mass % or more and 2.00 mass % or less and more preferably in a range of 0.1 mass % or more and less than 2.0 mass %.

An aluminum alloy further containing preferably 0.005 mass % or more and 2.000 mass % or less of Zn, in addition to Si and Fe described above, can also be used as an Al—Si—Fe-based alloy in order to further improve the smoothness of the plated surface of the aluminum alloy substrate. The element will be described below.

(Zinc)

Zn has the effect of reducing the amount of Al melted in zincate treatment and uniformly, thinly, and minutely depositing a zincate coating film to improve the smoothness and adhesiveness of plating in a subsequent step. The effect of reducing the amount of Al melted in zincate treatment and uniformly, thinly, and minutely depositing a zincate coating film to improve the smoothness of plating can be further obtained by setting the content of Zn in the aluminum alloy at 0.005 mass % or more. In addition, in the case of the bare material, a zincate coating film can be allowed to be uniform to further suppress the deterioration of the smoothness of the plated surface by setting the content of Zn in the aluminum alloy at 2.000 mass % or less. In the case of the clad material, a zincate coating film on a side of the substrate can be allowed to be uniform to suppress the deterioration of the adhesiveness of plating, and the peeling of plating in the boundary between the core material and the sheath material on the side of the substrate can be still more suppressed. Therefore, the content of Zn in the aluminum alloy is preferably in a range of 0.005 mass % or more and 2.000 mass % or less and more preferably in a range of 0.100 mass % or more and less than 2.000 mass %.

(Sodium, Strontium, Phosphorus)

Na, Sr, and P can provide the effect of allowing Si particles in the aluminum alloy substrate to be finer to improve plating properties. In addition, Na, Sr, and P have the effect of reducing nonuniformity in the sizes of the Si particles in the aluminum alloy substrate to reduce unevenness in rigidity in the aluminum alloy substrate. Therefore, one or more elements selected from the group consisting of preferably 0.001 mass % or more and 0.100 mass % or less of Na, preferably 0.001 mass % or more and 0.100 mass % or less of Sr, and preferably 0.001 mass % or more and 0.100 mass % or less of P may be selectively added into the aluminum alloy. However, the above-described effects are unable to be obtained when each of Na, Sr, and of P is less than 0.001 mass %. In contrast, even when more than 0.100% of each of Na, Sr, and P is contained, the effects are saturated, and further noticeable improvement effects are unable to be obtained. The content of each of Na, Sr, and P in the case of adding Na, Sr, and P is more preferably in a range of 0.003 mass % or more and 0.025 mass % or less.

(Titanium, Boron)

Ti and B form a boride, such as TiB₂, or Al₃Ti, which becomes a crystal grain nucleus, in a coagulation process in casting, and therefore enable crystal grains to be finer. As the result, plating properties are improved. In addition, Ti and B have the effect of improving the rigidity of the aluminum alloy substrate. However, the above-described effects are unable to be obtained when the total of the contents of Ti and B is less than 0.005 mass %. In contrast, even when the total of the contents of Ti and B is more than 0.500 mass %, the effects are saturated, and further noticeable improvement effects are unable to be obtained. Therefore. The total of the contents of Ti and B in the case of adding Ti and B is preferably in a range of 0.005 mass % or more and 0.500 mass % or less and more preferably in a range of 0.010 mass % or more and 0.100 mass % or less.

(Other Elements)

In addition, the balance of the aluminum alloy according to the embodiment of the present disclosure consists of aluminum and unavoidable impurities. In such a case, the properties of the aluminum alloy substrate obtained in present disclosure are not deteriorated when each and the total of the unavoidable impurities (for example, V and the like) are 0.03% or less and 0.15% or less, respectively.

(Composition of Sheath Material)

The alloy components of the sheath material of the clad material included in the aluminum alloy substrate for a magnetic disk according to the embodiment of the present disclosure and the contents of the alloy components will now be described.

In the aluminum alloy substrate according to the embodiment of the present disclosure, the plated surface is allowed to be smoother by applying the sheath materials containing a small number of second phase particles to both surfaces of the core material although the excellent smoothness of the plated surface can be obtained even in the case of only the bare material.

In the aluminum alloy substrate according to the embodiment of the present disclosure, either pure Al or an Al—Mg-based alloy may be used in the sheath materials. Pure Al and the Al—Mg-based alloy contain a small number of relatively coarse second phase particles and are excellent in plating properties in comparison with other alloys.

The sheath material with pure Al used in the aluminum alloy substrate according to the embodiment of the present disclosure preferably contains 0.005 mass % or more and 0.600 mass % or less of Cu, 0.005 mass % or more and 0.600 mass % or less of Zn, 0.001 mass % or more and 0.300 mass % or less of Si, 0.001 mass % or more and 0.300 mass % or less of Fe, and the balance of Al and unavoidable impurities.

The sheath material with an Al—Mg-based alloy used in the aluminum alloy substrate according to the embodiment of the present disclosure preferably contains 0.3 mass % or more and 8.0 mass % or less of Mg, 0.005 mass % or more and 0.600 mass % or less of Cu, 0.005 mass % or more and 0.600 mass % or less of Zn, 0.010 mass % or more and 0.300 mass % or less of Cr, 0.001 mass % or more and 0.300 mass % or less of Si, 0.001 mass % or more and 0.300 mass % or less of Fe, and the balance of Al and unavoidable impurities.

(Distribution State of Second Phase Particles in Aluminum Alloy Substrate for Magnetic Disk)

The distribution state of the second phase particles in the core material of the clad material and bare material of the aluminum alloy substrate for a magnetic disk according to the embodiment of the present disclosure will now be described.

Second phase particles having a longest diameter of 3 μm or more and 100 μm or less have the effect of improving the rigidity of the aluminum alloy substrate. In the embodiment of the present disclosure, the second phase particles having a longest diameter of 3 μm or more and 100 μm or less are preferably dispersed at a distribution density of 100 particles/mm² or more and 50000 particles/mm² or less in the metal structure of the core material of the clad material or the bare material. The dispersion of the second phase particles having a longest diameter of 3 μm or more and 100 μm or less at a distribution density of 100 particles/mm² or more further results in sufficient rigidity. In addition, the dispersion of the second phase particles having a longest diameter of 3 μm or more and 100 μm or less at a distribution density of 50000 particles/mm² or less in the metal structure of the core material of the clad material or the bare material enables the falling-off of the second phase particles and the generation of large recesses to be suppressed in etching, zincate treatment, and cutting or grinding work and enables the deterioration of the smoothness of the plated surface to be further suppressed in the bare material. In addition, the dispersion enables the falling-off of the second phase particles on the side of the substrate and the generation of large recesses to be suppressed in etching, zincate treatment, and cutting and enables the peeling of plating in the boundary between the core material and the sheath material on the side of the substrate to be further suppressed in the clad material. Therefore, the second phase particles having a longest diameter of 3 μm or more and 100 μm or less are preferably dispersed at a distribution density of 100 particles/mm² or more and 50000 particles/mm² or less and more preferably dispersed at a distribution density of 1000 particles/mm² or more and less than 30000 particles/mm² in the metal structure of the core material of the clad material or the bare material. When the longest diameter of the second phase particles existing in the aluminum alloy substrate is less than 3 μm, recesses and the like generated due to the second phase particles are not perceived as problems and are therefore excluded from targets for the distribution density.

In addition, it is preferable that second phase particles having a longest diameter of more than 100 μm exist at 0 particles/mm² in the aluminum alloy substrate. When the second phase particles having a longest diameter of more than 100 μm exist at 1 particle/mm² or more, the second phase particles may fall off, thereby generating large recesses, in etching, zincate treatment, and cutting or grinding work, and a smooth plated surface may be prevented from being obtained in the bare material. In the clad material, the second phase particles on the side of the substrate may fall off, thereby generating large recesses, in etching, zincate treatment, and cutting, and the plating may peel in the boundary between the core material and the sheath material on the side of the substrate. In a planar image of second phase particles observed with an optical microscope, first, a maximum value of the distance between one point on a contour and another point on the contour is measured, such maximum values with regard to all the points on the contour are then measured, and the highest value is finally selected from all the maximum values; and the longest diameter refers to the highest value in the present disclosure.

(Method for Producing Aluminum Alloy Substrate for Magnetic Disk)

Each step and process conditions of steps for producing an aluminum alloy substrate for a magnetic disk according to an embodiment of the present disclosure will be described in detail below.

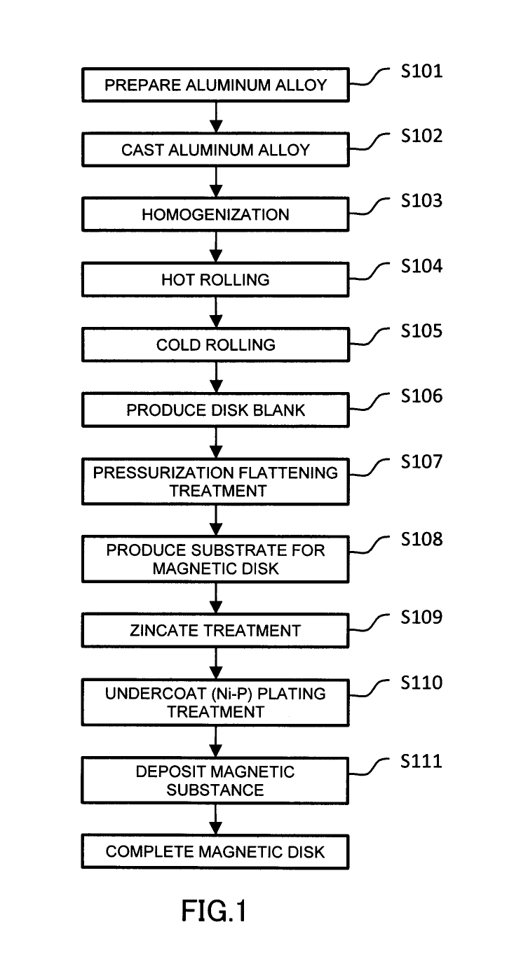

A method for producing a magnetic disk using a bare material as an aluminum alloy substrate for a magnetic disk is described with reference to a flow illustrated in FIG. 1. In such a case, the steps from preparation of an aluminum alloy (step S101) to cold rolling (step S105) are the steps of producing an aluminum alloy sheet, and the steps from production of a disk blank (step S106) to deposition of magnetic substance (step S111) are the steps of making the produced aluminum alloy sheet into a magnetic disk. First, the steps for producing the aluminum alloy substrate for a magnetic disk, which is the bare material, are described.

First, a molten aluminum alloy having the component composition described above is prepared by heating and melting according to a usual method (step S101). Then, an aluminum alloy is cast from the prepared molten aluminum alloy by a semi-continuous casting (DC casting) method, a continuous casting (CC) method, or the like (step S102). A cooling rate in the casting is preferably in a range of 0.1 to 1000° C./s. When the cooling rate in the casting is less than 0.1° C./s, the dispersion density of second phase particles having a longest diameter of 3 to 100 μm is more than 50000 particles/mm², second phase particles may fall off, thereby generating large recesses, in etching, zincate treatment, and cutting or grinding work, and the smoothness of a plated surface may be deteriorated. In contrast, when the cooling rate in the casting is more than 1000° C./s, the dispersion density of the second phase particles having a longest diameter of 3 to 100 μm is less than 100 particles/mm², and sufficient rigidity is unable to be obtained. A higher cooling rate in the casting results in the denser distribution of fine second phase particles, thereby stabilizing performance, and therefore, the CC method of which the cooling rate is higher than that of the DC casting method is more preferred as the casting method. Then, homogenization treatment of the cast aluminum alloy is performed (step S103). The homogenization treatment need not be performed. However, when the homogenization treatment is performed, it is preferable to perform the homogenization treatment under conditions of, for example, 400 to 500° C., 1 hour or more, and the like. Then, hot rolling of the aluminum alloy subjected to the homogenization treatment is performed to make a sheet material (step S104). The conditions of the hot rolling are not particularly limited, but a hot-rolling start temperature is set at 300 to 500° C., and a hot-rolling end temperature is set at 260 to 400° C. Then, cold rolling of the sheet subjected to the hot rolling is performed to make an aluminum alloy sheet of around 1.0 mm (step S105). After the hot rolling, the sheet is finished to have a needed product sheet thickness by the cold rolling. The conditions of the cold rolling are not particularly limited but may be determined depending on a needed product sheet strength and/or sheet thickness, and a rolling reduction is set at 20 to 80%. Before or during the cold rolling, annealing treatment may be performed to secure cold-rolling workability. The annealing treatment is preferably performed under conditions of 300 to 450° C. and 0.1 to 10 hours in the case of, for example, batch-type heating and is preferably performed under conditions of maintenance at 400 to 500° C. for 0 to 60 seconds in the case of continuous heating.

In order to work the aluminum alloy sheet for a magnetic disk, the aluminum alloy sheet is stamped in an annular shape to produce a disk blank (step S106). Then, the disk blank is subjected to pressurization annealing in atmospheric air at 300° C. or more and 450° C. or less for 30 minutes or more to produce a flattened aluminum alloy substrate (step S107). Then, the aluminum alloy substrate is cutting-worked, grinding-worked, degreased, and etched (step S108). Then, a surface of the aluminum alloy substrate is subjected to zincate treatment (Zn substitution treatment) (step S109). Then, the surface subjected to the zincate treatment is subjected to undercoat treatment (Ni—P plating) to produce an aluminum alloy base (step S110). Then, a magnetic substance is deposited on the surface subjected to the undercoat treatment by sputtering to make a magnetic disk (step S111).

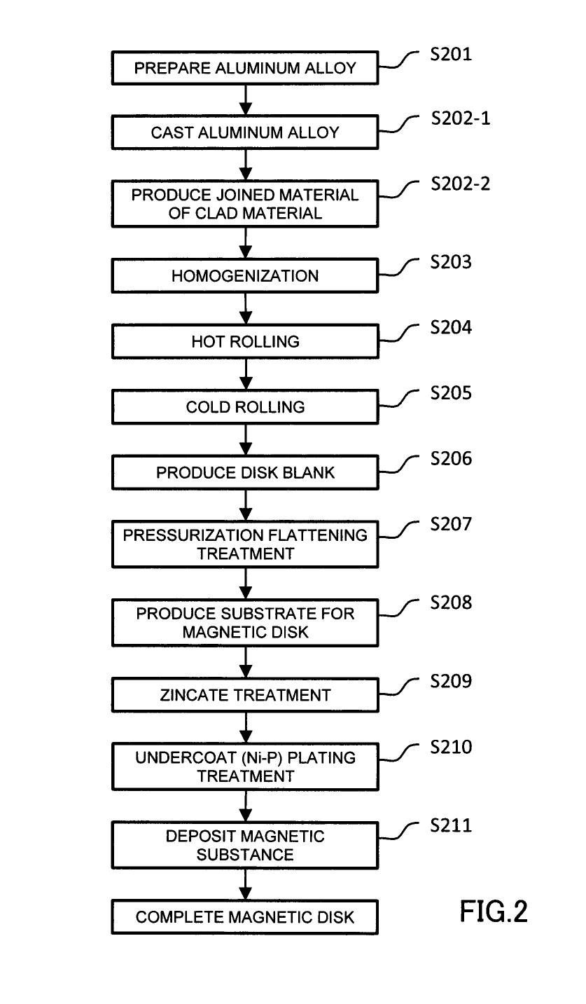

A method for producing a magnetic disk by using an aluminum alloy substrate for a magnetic disk, which is a clad material, will now be described with reference to a flow illustrated in FIG. 2. In such a case, the steps from preparation of an aluminum alloy (step S201) to cold rolling (step S205) are the steps of producing an aluminum alloy sheet, and the steps from production of a disk blank (step S206) to deposition of magnetic substance (step S211) are the steps of making the produced aluminum alloy sheet into a magnetic disk.

First, a molten aluminum alloy having the component composition described above is prepared for a core material and sheath materials by heating and melting according to a usual method (step S201). Then, an aluminum alloy is cast from the molten aluminum alloy blended to have the desired composition by a semi-continuous casting (DC casting) method, a continuous casting (CC) method, or the like (step S202-1). Then, there are performed: a step of performing homogenization treatment of an ingot for a sheath material and hot-rolling the ingot to make desired sheath materials; and a step of facing an ingot for a core material to make a core material having a desired sheet thickness and joining the sheath materials to both surfaces of the core material to make a joined material (step S202-2).

When the aluminum alloy substrate for a magnetic disk, which is the clad material, is produced by a rolling pressure welding method, an ingot prepared by, for example, a semi-continuous casting (DC casting) method, a continuous casting (CC) method, or the like is used as the core material. By removing an oxide film by mechanical removal such as facing or cutting and/or chemical removal such as alkali cleaning after the casting, the subsequent pressure welding of the core material and the sheath materials is favorably performed (steps S202-1, S202-2).

For the sheath materials, an ingot obtained by a DC casting method, a CC method, or the like is faced and hot-rolled to make a sheet material having a predetermined size. Before the hot rolling, homogenization treatment may or need not be performed; however, when the homogenization treatment is performed, it is preferable to perform the homogenization treatment under conditions of 350° C. or more and 550° C. or less, 1 hour or more, and the like. The conditions of the hot rolling for allowing the sheath materials to have a desired thickness are not particularly limited, but it is preferable to set a hot-rolling start temperature at 350° C. or more and 500° C. or less and to set a hot-rolling end temperature at 260° C. or more and 380° C. or less. In addition, by washing, only with nitric acid, caustic soda, or the like, the blank subjected to the hot rolling for allowing the sheath materials to have the desired thickness, an oxide film generated in the hot rolling is removed, and the pressure welding of the core material is favorably performed (steps S202-1, S202-2).

In the embodiment of the present disclosure, the cladding rate of the sheath material (the rate of the thickness of the sheath material with respect to the total thickness of the clad material) for cladding the core material and the sheath material is not particularly limited but is set as appropriate according to needed product sheet strength and/or flatness and a cutting depth, is preferably set at 3% or more and 30% or less, and is more preferably set at 5% or more and 20% or less. For example, a step of hot rolling to make sheath materials having a sheet thickness of around 15 mm is performed, an ingot for a core material is faced to make a core material having a sheet thickness of around 270 mm, and the sheath materials are joined to both surfaces of the core material to make a joined material.

Then, homogenization treatment of the cast aluminum alloy is performed (step S203). The homogenization treatment of the joined material of the core material and the sheath materials is preferably performed under conditions of, for example, 400° C. or more and 500° C. or less, 1 hour or more, and the like.

When the homogenization treatment of the joined material of the core material and the sheath materials is performed, it is necessary to suppress generation of an oxide film in the interfaces between the core material and the sheath materials as much as possible. For such a purpose, homogenization treatment of an aluminum alloy having composition in which an oxide film is prone to be generated is preferably performed in a non-oxidizing atmosphere such as, for example, an inert gas such as nitrogen gas or argon gas, a reducing gas such as carbon monoxide, or a gas under a reduced pressure such as a vacuum.

Then, hot rolling of the aluminum alloy subjected to the homogenization treatment is performed to make a sheet material (step S204). The core material and the sheath materials are cladded by performing the hot rolling. The conditions of the hot rolling are not particularly limited, but a hot-rolling start temperature is preferably 300° C. or more and 500° C. or less, and a hot-rolling end temperature is preferably 260° C. or more and 400° C. or less. In such a case, the thickness of the sheet is set at around 3.0 mm.

The aluminum alloy sheet obtained by the hot rolling is finished to have a desired product sheet thickness by cold rolling (step S205). The conditions of the cold rolling are not particularly limited but may be determined depending on a needed product sheet strength and/or sheet thickness, and a rolling reduction is preferably 20% or more and 80% or less.

Before or during the cold rolling, annealing treatment may be performed to secure cold-rolling workability. The annealing treatment is preferably performed under conditions of 300° C. or more and 450° C. or less and 0.1 hours or more and 10 hours or less in the case of, for example, batch-type heating. In such a case, the thickness of the sheet is set at around 1.0 mm.

All of the steps described above contributes to the generation of the second phase particles. However, the properties of the aluminum alloy substrate for a magnetic disk, which is the core material, according to the embodiment of the present disclosure are particularly greatly influenced by a cooling rate in the casting of the core material in the step S202-1. The cooling rate in the casting of the core material is preferably set at 0.1° C./s or more and 1000° C./s or less in order to obtain the desired distribution of the second phase particles.

When the cooling rate in the casting of the core material is less than 0.1° C./s, the distribution density of second phase particles having a longest diameter of 3 μm or more and 100 μm or less is more than 50000 particles/mm², second phase particles on a side of the substrate may fall off, thereby generating large recesses, in etching, zincate treatment, and cutting, and plating may peel in the boundary between the core material and the sheath material on the side of the substrate. In contrast, when the cooling rate in the casting of the core material is more than 1000° C./s, the distribution density of the second phase particles having a longest diameter of 3 μm or more and 100 μm or less is less than 100 particles/mm², and sufficient rigidity is unable to be obtained. Accordingly, the cooling rate in the casting of the core material is preferably in a range of 0.1° C./s or more and 1000° C./s or less.

In the embodiment of the present disclosure, various methods can be applied to the cladding of the core material and the sheath materials. Examples of such methods include a rolling pressure welding method which is usually used in production of a brazing sheet, or the like. The rolling pressure welding method is performed by subjecting the joined material of the core material and the sheath materials to the homogenization treatment (step S203), the hot rolling (step S204), and the cold rolling (step S205) in the order mentioned above.

The steps of the production of a disk blank (step S206) to the deposition of a magnetic substance (step S211) are performed in order to work the aluminum alloy sheet, which is the clad material, for use in a magnetic disk. The steps of the production of a disk blank (step S206) to the deposition of a magnetic substance (step S211) are similar to the steps of the production of a disk blank (step S106) to the deposition of a magnetic substance (step S111), which are the steps for working the aluminum alloy sheet, which is the bare material, for use in a magnetic disk.

### EXAMPLES

The present disclosure will be described in more detail below with reference to examples. However, the present disclosure is not limited thereto.

(Aluminum Alloy Substrate for Magnetic Disk, which is Bare Material)

First, examples of the aluminum alloy substrate for a magnetic disk, which is a bare material, will be described. Each alloy with component composition listed in Table 1 and Table 2 was melted to make a molten aluminum alloy according to a usual method (step S101). In Table 1 and Table 2, “-” denotes a measurement limit value or less.

TABLE 1

| | Component Composition (mass %) | | | | | | | | | | | | | |
|---|---|---|---|---|---|---|---|---|---|---|---|---|---|---|
| | | | | | | | | | | | | | | Al + |
| Alloy | | | | | | | | | | | | | | unavoidable |
| No. | Si | Fe | Cu | Mg | Ni | Cr | Mn | Zn | Na | Sr | P | Ti | B | impurities |
| A1 | 5.2 | 2.980 | — | — | — | — | — | — | — | — | — | — | — | Bal. |
| A2 | 5.5 | 0.010 | — | — | — | — | — | — | — | — | — | — | — | Bal. |
| A3 | 5.3 | 0.050 | — | — | — | — | — | — | — | — | — | — | — | Bal. |
| A4 | 5.6 | 0.100 | — | — | — | — | — | — | — | — | — | — | — | Bal. |
| A5 | 8.2 | 0.200 | — | — | — | — | — | — | — | — | — | — | — | Bal. |
| A6 | 11.0 | 1.502 | — | — | — | — | — | — | 0.002 | — | — | — | — | Bal. |
| A7 | 13.0 | 0.200 | — | — | — | — | — | — | — | 0.002 | — | — | — | Bal. |
| A8 | 18.0 | 0.212 | — | — | — | — | — | — | — | — | 0.002 | — | — | Bal. |
| A9 | 8.3 | 0.200 | 1.032 | — | — | — | — | — | 0.010 | — | — | — | — | Bal. |
| A10 | 5.3 | 0.030 | — | — | — | — | — | — | — | — | — | — | — | Bal. |
| A11 | 15.0 | 0.296 | — | 1.0 | — | — | — | — | — | — | — | 0.454 | 0.023 | Bal. |
| A12 | 15.0 | 0.305 | — | — | 1.0 | — | — | — | 0.090 | — | — | — | — | Bal. |
| A13 | 16.0 | 0.302 | — | — | — | 1.00 | — | — | — | 0.090 | — | — | — | Bal. |
| A14 | 18.0 | 0.503 | — | — | — | — | 1.02 | — | — | — | 0.090 | — | — | Bal. |
| A15 | 20.0 | 0.100 | — | — | — | — | — | 0.520 | — | — | — | 0.005 | 0.001 | Bal. |
| A16 | 22.0 | 0.100 | — | — | — | — | — | — | — | — | — | 0.053 | 0.010 | Bal. |
| A17 | 23.8 | 0.100 | — | — | — | — | — | — | — | — | — | — | — | Bal. |
| A18 | 11.0 | 0.300 | 0.005 | — | — | — | — | — | — | — | — | — | — | Bal. |
| A19 | 12.0 | 0.200 | 1.987 | — | — | — | — | — | — | — | — | — | — | Bal. |
| A20 | 12.0 | 0.204 | — | 0.1 | — | — | — | — | — | — | — | — | — | Bal. |

TABLE 2

| | Component Composition (mass %) | | | | | | | | | | | | | |
|---|---|---|---|---|---|---|---|---|---|---|---|---|---|---|
| | | | | | | | | | | | | | | Al + |
| Alloy | | | | | | | | | | | | | | unavoidable |
| No. | Si | Fe | Cu | Mg | Ni | Cr | Mn | Zn | Na | Sr | P | Ti | B | impurities |
| A21 | 12.0 | 0.200 | — | 2.0 | — | — | — | — | — | — | — | — | — | Bal. |
| A22 | 12.0 | 0.203 | — | — | 0.1 | — | — | — | — | — | — | — | — | Bal. |
| A23 | 12.0 | 0.192 | — | — | 2.0 | — | — | — | — | — | — | — | — | Bal. |
| A24 | 12.0 | 0.201 | — | — | — | 0.01 | — | — | — | — | — | — | — | Bal. |
| A25 | 12.0 | 0.203 | — | — | — | 2.00 | — | — | — | — | — | — | — | Bal. |
| A26 | 12.0 | 0.195 | — | — | — | — | 0.01 | — | — | — | — | — | — | Bal. |
| A27 | 12.0 | 0.208 | — | — | — | — | 2.00 | — | — | — | — | — | — | Bal. |
| A28 | 12.0 | 0.204 | — | — | — | — | — | 0.005 | — | — | — | — | — | Bal. |
| A29 | 12.0 | 0.200 | — | — | — | — | — | 1.992 | — | — | — | — | — | Bal. |
| A30 | 12.0 | 0.203 | 1.012 | — | — | — | — | 1.032 | — | — | — | — | — | Bal. |
| A31 | 12.0 | 0.203 | — | 6.0 | — | — | — | 1.003 | — | — | — | — | — | Bal. |
| A32 | 12.0 | 0.201 | — | — | 1.0 | — | — | 1.002 | — | — | — | — | — | Bal. |
| A33 | 12.0 | 0.208 | — | — | — | 1.00 | — | 1.004 | — | — | — | — | — | Bal. |
| A34 | 12.0 | 0.202 | — | — | — | — | 1.00 | 1.008 | — | — | — | — | — | Bal. |
| A35 | 5.8 | 0.203 | 0.305 | 0.3 | 0.3 | 0.10 | 0.11 | — | — | — | — | — | — | Bal. |
| A36 | 18.0 | 0.208 | 1.021 | 1.0 | 1.0 | 1.02 | 1.03 | 1.008 | — | 0.010 | — | — | — | Bal. |
| A37 | 0.6 | 2.901 | — | — | — | — | — | — | — | — | — | — | — | Bal. |
| A38 | 1.2 | 2.890 | — | — | — | — | — | — | — | — | — | — | — | Bal. |
| A39 | 1.7 | 2.780 | — | — | — | — | — | — | — | — | — | — | — | Bal. |
| A40 | 4.8 | 2.521 | — | — | — | — | — | — | — | — | — | — | — | Bal. |
| A41 | 4.5 | 2.700 | 0.320 | 0.3 | 0.3 | 0.10 | 0.10 | — | 0.01 | — | — | — | — | Bal. |
| A42 | 3.8 | 2.890 | 1.008 | 1.0 | 1.0 | 1.02 | 1.01 | 1.001 | — | 0.010 | — | 0.01 | 0.001 | Bal. |
| A43 | 4.0 | 2.760 | — | — | — | — | — | — | — | — | 0.002 | — | — | Bal. |
| AC1 | 0.3 | 0.108 | — | — | — | — | — | — | — | — | — | — | — | Bal. |
| AC2 | 24.8 | 0.200 | — | — | — | — | — | — | — | — | — | — | — | Bal. |
| AC3 | 0.5 | 0.004 | — | — | — | — | — | — | — | — | — | — | — | Bal. |
| AC4 | 5.2 | 3.200 | — | — | — | — | — | — | — | — | — | — | — | Bal. |

Then, molten aluminum alloys in alloys Nos. A1 to A7, A11 to A36, and AC1 to AC4 were cast by a DC casting method, and molten aluminum alloys in alloys Nos. A8 to A10 were cast by a CC method to produce ingots as listed in Table 3 and Table 4 (step S102).

TABLE 3

| | | Casting conditions | | Ingot |
|---|---|---|---|---|
| | Alloy | | Casting velocity | sheet thickness |
| | No. | Casting method | (mm/min) | (mm) |
| Example 1 | A1 | DC | 30 | 300 |
| Example 2 | A2 | DC | 30 | 300 |
| Example 3 | A3 | DC | 30 | 300 |
| Example 4 | A4 | DC | 30 | 300 |
| Example 5 | A5 | DC | 30 | 300 |
| Example 6 | A6 | DC | 30 | 300 |
| Example 7 | A7 | DC | 30 | 300 |
| Example 8 | A8 | CC | 1400 | 6 |
| Example 9 | A9 | CC | 1000 | 3 |
| Example 10 | A10 | CC | 600 | 3 |
| Example 11 | A11 | DC | 40 | 300 |
| Example 12 | A12 | DC | 40 | 300 |
| Example 13 | A13 | DC | 40 | 300 |
| Example 14 | A14 | DC | 40 | 300 |
| Example 15 | A15 | DC | 20 | 300 |
| Example 16 | A16 | DC | 20 | 300 |
| Example 17 | A17 | DC | 10 | 300 |
| Example 18 | A18 | DC | 40 | 300 |
| Example 19 | A19 | DC | 40 | 300 |
| Example 20 | A20 | DC | 40 | 300 |

TABLE 4

| | | Casting conditions | | Ingot |
|---|---|---|---|---|
| | Alloy | | Casting velocity | sheet thickness |
| | No. | Casting method | (mm/min) | (mm) |
| Example 21 | A21 | DC | 50 | 300 |
| Example 22 | A22 | DC | 50 | 300 |
| Example 23 | A23 | DC | 50 | 300 |
| Example 24 | A24 | DC | 50 | 300 |
| Example 25 | A25 | DC | 50 | 300 |
| Example 26 | A26 | DC | 50 | 300 |
| Example 27 | A27 | DC | 50 | 300 |
| Example 28 | A28 | DC | 50 | 300 |
| Example 29 | A29 | DC | 50 | 300 |
| Example 30 | A30 | DC | 50 | 300 |
| Example 31 | A31 | DC | 50 | 300 |
| Example 32 | A32 | DC | 50 | 300 |
| Example 33 | A33 | DC | 50 | 300 |
| Example 34 | A34 | DC | 50 | 300 |
| Example 35 | A35 | DC | 60 | 300 |
| Example 36 | A36 | DC | 60 | 300 |
| Example 37 | A37 | DC | 50 | 300 |
| Example 38 | A38 | DC | 50 | 300 |
| Example 39 | A39 | DC | 50 | 300 |
| Example 40 | A40 | DC | 50 | 300 |
| Example 41 | A41 | DC | 50 | 300 |
| Example 42 | A42 | DC | 50 | 300 |
| Example 43 | A43 | DC | 50 | 300 |
| Comparative | AC1 | DC | 30 | 300 |
| Example 1 | | | | |
| Comparative | AC2 | DC | 30 | 300 |
| Example 2 | | | | |
| Comparative | AC3 | DC | 30 | 300 |
| Example 3 | | | | |
| Comparative | AC4 | DC | 30 | 300 |
| Example 4 | | | | |

Both surfaces of each of the ingots of the alloys Nos. A1 to A7, A11 to A36, and AC1 to AC4 were faced in 15 mm. The alloys Nos. A1 to A9, A11 to A36, and AC1 to AC4 were subjected to homogenization treatment at 480° C. for 3 hours (step S103). Hot rolling of the alloys Nos. A1 to A8, A11 to A36, and AC1 to AC4 was performed at a rolling start temperature of 460° C. and a rolling end temperature of 340° C. to make hot-rolled sheets having a sheet thickness of 3.0 mm (step S104). The hot-rolled sheets of the alloys Nos. A1 to A6, A8 to A36, and AC1 to AC4 were annealed under conditions of 400° C. and 2 hours and cold-rolled (rolling reduction of 66.7%) to have a final sheet thickness of 1.0 mm to make each aluminum alloy sheet (step S105). A disk blank was stamped and produced to have an annular shape with an outer diameter of 96 mm and an inner diameter of 24 mm from the aluminum alloy sheet (step S106).

The disk blank was subjected to pressurization annealing at 400° C. for 3 hours (step S107). The disk blank was subjected to end-surface preparation to have an outer diameter of 95 mm and an inner diameter of 25 mm and was subjected to grinding work (grinding of surface of 10 μm) (step S108). Then, the disk blank was degreased at 60° C. for 5 minutes by AD-68F (manufactured by C. Uyemura & Co., Ltd.), etched at 65° C. for 1 minute by AD-107F (manufactured by C. Uyemura & Co., Ltd.), and further desmutted with 30% HNO₃ aqueous solution (room temperature) for 20 seconds. Zincate treatment of a surface of the disk blank of which the surface was prepared was performed using AD-301F-3X (manufactured by C. Uyemura & Co., Ltd.) (step S109). The surface subjected to the zincate treatment was electroless plated with Ni—P of 17 μm in thickness using an electroless Ni—P plating treatment liquid (NIMUDEN HDX (manufactured by C. Uyemura & Co., Ltd.)) and then subjected to final polishing (polishing quantity of 4 μm)) by a fabric (step S110).

The aluminum alloy ingot after the casting (step S102) step, the aluminum alloy sheet after the cold rolling (step S105) step, the aluminum alloy substrate after the grinding work (step S108) step, and the aluminum alloy base after the plating treatment polishing (step S110) step were subjected to the following evaluations.

[Cooling Rate in Casting]

The dendrite arm spacing (DAS) of the ingot after the casting (step S102) was measured to calculate a cooling rate in the casting. A cross-sectional structure in an ingot thickness direction was observed with an optical microscope, and the DAS was measured by a secondary arm method. The cross section of the center in the thickness direction of the ingot was used for the measurement.

[Rigidity]

The aluminum alloy sheet after the cold rolling (step S105) was heated under conditions of 400° C. and 3 hours, followed by measuring the Young's modulus of the aluminum alloy sheet by a resonance method to evaluate the rigidity of the aluminum alloy sheet. The measurement of the rigidity was performed at room temperature using a JE-RT type apparatus manufactured by Nihon Techno-Plus Corp. Such an aluminum alloy sheet having a Young's modulus of 75 GPa or more was regarded as “excellent” (mark “⊚”), such an aluminum alloy sheet having a Young's modulus of 72 GPa or more and less than 75 GPa was regarded as “good” (mark “∘”), and such an aluminum alloy sheet having a Young's modulus of less than 72 GPa was regarded as “poor” (mark “x”).

[Distribution Densities of Second Phase Particles Having Longest Diameter of 3 to 100 μm and Longest Diameter of More than 100 μm]

The distribution densities (particles/mm²) of second phase particles having a longest diameter of 3 to 100 μm and a longest diameter of more than 100 μm were determined by observing 1 mm² of a cross section of the aluminum alloy substrate after the grinding work (step S108) with an optical microscope at a 400-fold magnification and by counting the second phase particles having a longest diameter of 3 to 100 μm and a longest diameter of more than 100 μm.

[Smoothness of Plated Surface]

Observation of 1 mm² of the surface of the aluminum alloy base after Ni—P plating treatment polishing (step S110) was performed with an optical microscope at a 500-fold magnification, the number of pits with a size having a longest diameter of 5 μm or more was counted, and the number of pits per unit area (number density: pits/mm²) was determined. The case of 0 to 10 pits/mm² was regarded as “excellent” (mark “⊚”), the case of 10 to 20 pits/mm² was regarded as “good” (mark “∘”), and the case of more than 20 pits/mm² was regarded as “poor” (mark “x”). The above evaluation results are listed in Table 5 and Table 6.

TABLE 5

| | | | | Distribution of | | Distribution of | Distribution of | |
|---|---|---|---|---|---|---|---|---|
| | | | | plating pits | | second phase | second phase | |
| | | | | having longest | | particles having | particles having | |
| | | | | diameter of 5 μm | | longest diameter | longest diameter | |
| | | Young's modulus | | or more | Smoothness of | of 3 to 100 μm | of more than 100 μm | Cooling rate in |
| | Alloy No. | (GPa) | Rigidity | (pits/mm²) | plated surface | (particles/mm²) | (particles/mm²) | casting (° C./s) |
| Example 1 | A1 | 75 | ⊚ | 8 | ⊚ | 43241 | 0 | 0.4 |
| Example 2 | A2 | 73 | ◯ | 1 | ⊚ | 88 | 0 | 0.3 |
| Example 3 | A3 | 75 | ⊚ | 2 | ⊚ | 102 | 0 | 0.5 |
| Example 4 | A4 | 75 | ⊚ | 2 | ⊚ | 153 | 0 | 0.8 |
| Example 5 | A5 | 77 | ⊚ | 3 | ⊚ | 655 | 0 | 0.4 |
| Example 6 | A6 | 79 | ⊚ | 5 | ⊚ | 15036 | 0 | 0.5 |
| Example 7 | A7 | 79 | ⊚ | 4 | ⊚ | 10058 | 0 | 0.3 |
| Example 8 | A8 | 82 | ⊚ | 5 | ⊚ | 35059 | 0 | 212.0 |
| Example 9 | A9 | 76 | ⊚ | 3 | ⊚ | 456 | 0 | 891.0 |
| Example 10 | A10 | 73 | ◯ | 2 | ⊚ | 78 | 0 | 1083.0 |
| Example 11 | A11 | 81 | ⊚ | 7 | ⊚ | 34218 | 0 | 0.8 |
| Example 12 | A12 | 81 | ⊚ | 8 | ⊚ | 37768 | 0 | 0.8 |
| Example 13 | A13 | 82 | ⊚ | 8 | ⊚ | 38213 | 0 | 0.9 |
| Example 14 | A14 | 83 | ⊚ | 8 | ⊚ | 39811 | 0 | 0.8 |
| Example 15 | A15 | 84 | ⊚ | 9 | ⊚ | 42122 | 0 | 0.2 |
| Example 16 | A16 | 85 | ⊚ | 9 | ⊚ | 48213 | 0 | 0.2 |
| Example 17 | A17 | 86 | ⊚ | 13 | ◯ | 52101 | 0 | 0.05 |
| Example 18 | A18 | 78 | ⊚ | 4 | ⊚ | 11235 | 0 | 0.7 |
| Example 19 | A19 | 79 | ⊚ | 6 | ⊚ | 25948 | 0 | 0.8 |
| Example 20 | A20 | 77 | ⊚ | 5 | ⊚ | 15367 | 0 | 0.9 |

TABLE 6

| | | | | Distribution of plating | | Distribution of second | Distribution of second phase | Cooling |
|---|---|---|---|---|---|---|---|---|
| | | Young's | | pits having longest | Smoothness | phase particles having | particles having longest | rate in |
| | Alloy | modulus | | diameter of 5 μm or | of plated | longest diameter of 3 to | diameter of more than 100 μm | casting |
| | No. | (GPa) | Rigidity | more (pits/mm²) | surface | 100 μm (particles/mm²) | (particles/mm²) | (° C./s) |
| Example 21 | A21 | 79 | ⊚ | 6 | ⊚ | 28746 | 0 | 1.0 |
| Example 22 | A22 | 77 | ⊚ | 4 | ⊚ | 17506 | 0 | 1.1 |
| Example 23 | A23 | 78 | ⊚ | 8 | ⊚ | 32145 | 0 | 0.9 |
| Example 24 | A24 | 77 | ⊚ | 4 | ⊚ | 15438 | 0 | 0.8 |
| Example 25 | A25 | 78 | ⊚ | 7 | ⊚ | 30324 | 0 | 0.5 |
| Example 26 | A26 | 77 | ⊚ | 3 | ⊚ | 13323 | 0 | 0.5 |
| Example 27 | A27 | 78 | ⊚ | 6 | ⊚ | 31872 | 0 | 0.5 |
| Example 28 | A28 | 78 | ⊚ | 4 | ⊚ | 18213 | 0 | 0.8 |
| Example 29 | A29 | 79 | ⊚ | 5 | ⊚ | 11202 | 0 | 0.9 |
| Example 30 | A30 | 78 | ⊚ | 7 | ⊚ | 21271 | 0 | 0.8 |
| Example 31 | A31 | 78 | ⊚ | 6 | ⊚ | 22192 | 0 | 0.8 |
| Example 32 | A32 | 78 | ⊚ | 7 | ⊚ | 26813 | 0 | 0.9 |
| Example 33 | A33 | 77 | ⊚ | 5 | ⊚ | 25436 | 0 | 0.5 |
| Example 34 | A34 | 78 | ⊚ | 6 | ⊚ | 23758 | 0 | 0.5 |
| Example 35 | A35 | 76 | ⊚ | 8 | ⊚ | 9249 | 0 | 1.1 |
| Example 36 | A36 | 82 | ⊚ | 7 | ⊚ | 43210 | 0 | 1.2 |
| Example 37 | A37 | 72 | ◯ | 1 | ⊚ | 1302 | 0 | 0.8 |
| Example 38 | A38 | 72 | ◯ | 1 | ⊚ | 1532 | 0 | 0.9 |
| Example 39 | A39 | 73 | ◯ | 1 | ⊚ | 1921 | 0 | 0.8 |
| Example 40 | A40 | 74 | ◯ | 1 | ⊚ | 2695 | 0 | 0.8 |
| Example 41 | A41 | 74 | ◯ | 2 | ⊚ | 3120 | 0 | 0.9 |
| Example 42 | A42 | 74 | ◯ | 2 | ⊚ | 3129 | 0 | 0.8 |
| Example 43 | A43 | 74 | ◯ | 1 | ⊚ | 2128 | 0 | 0.9 |
| Comparative | AC1 | 69 | X | 1 | ⊚ | 23 | 0 | 0.4 |
| Example 1 | | | | | | | | |
| Comparative | AC2 | 83 | ⊚ | 23 | X | 58418 | 1 | 0.3 |
| Example 2 | | | | | | | | |
| Comparative | AC3 | 68 | X | 1 | ⊚ | 12 | 0 | 0.5 |
| Example 3 | | | | | | | | |
| Comparative | AC4 | 75 | ⊚ | 22 | X | 59256 | 1 | 0.5 |
| Example 4 | | | | | | | | |

As shown in Table 5 and Table 6, the aluminum alloy substrate for a magnetic disk, including a smooth plated surface and having high rigidity, was obtained in each of Example 1 to Example 43. In contrast, Comparative Example 1 to Comparative Example 4 were poor in the smoothness of a plated surface or rigidity. Comparative Example 1 resulted in a low Young's modulus and poor rigidity due to the low content of Si. Comparative Example 2 resulted in generation of a large number of coarse Si particles due to the high content of Si and therefore in falling-off of the Si particles in plating pretreatment, thereby generating large recesses. As a result, a large number of pits were generated on a plated surface, and the smoothness of the plated surface was deteriorated. Comparative Example 3 resulted in a low Young's modulus and poor rigidity due to the low content of Fe. Comparative Example 4 resulted in generation of a large amount of a coarse Al—Fe—Si-based compound due to the high content of Fe and therefore in falling-off of the compound in plating pretreatment, thereby generating large recesses. As a result, a large number of pits were generated on a plated surface, and the smoothness of the plated surface was deteriorated.

(Clad Material Aluminum Alloy Substrate for Magnetic Disk)

Examples of the aluminum alloy substrate for a magnetic disk, which is a clad material, will now be described.

Each alloy with component composition listed in Table 7 to Table 10 was melted to make a molten aluminum alloy according to a usual method (step S201). The component composition of the core material of the clad material is listed in Table 7 and Table 8, and the component composition of the sheath material of the clad material listed in Table 9 and Table 10. In Table 7 to Table 10, “-” denotes a measurement limit value or less.

TABLE 7

| | Component composition of core material (mass %) | | | | | | | | | | | | | |
|---|---|---|---|---|---|---|---|---|---|---|---|---|---|---|
| | | | | | | | | | | | | | | Al + |
| Alloy | | | | | | | | | | | | | | unavoidable |
| No. | Si | Fe | Cu | Mg | Ni | Cr | Mn | Zn | Na | Sr | P | Ti | B | impurities |
| B1 | 5.2 | 2.980 | — | — | — | — | — | — | — | — | — | — | — | Bal. |
| B2 | 5.5 | 0.010 | — | — | — | — | — | — | — | — | — | — | — | Bal. |
| B3 | 5.3 | 0.050 | — | — | — | — | — | — | — | — | — | — | — | Bal. |
| B4 | 5.6 | 0.100 | — | — | — | — | — | — | — | — | — | — | — | Bal. |
| B5 | 8.2 | 0.200 | — | — | — | — | — | — | — | — | — | — | — | Bal. |
| B6 | 11.0 | 1.502 | — | — | — | — | — | — | 0.002 | — | — | — | — | Bal. |
| B7 | 13.0 | 0.200 | — | — | — | — | — | — | — | 0.002 | — | — | — | Bal. |
| B8 | 18.0 | 0.212 | — | — | — | — | — | — | — | — | 0.002 | — | — | Bal. |
| B9 | 8.3 | 0.200 | 1.032 | — | — | — | — | — | 0.010 | — | — | — | — | Bal. |
| B10 | 5.3 | 0.030 | — | — | — | — | — | — | — | — | — | — | — | Bal. |
| B11 | 15.0 | 0.296 | — | 0.9 | — | — | — | — | — | — | — | 0.454 | 0.023 | Bal. |
| B12 | 15.0 | 0.305 | — | — | 1.0 | — | — | — | 0.090 | — | — | — | — | Bal. |
| B13 | 16.0 | 0.302 | — | — | — | 1.00 | — | — | — | 0.090 | — | — | — | Bal. |
| B14 | 18.0 | 0.503 | — | — | — | — | 1.02 | — | — | — | 0.090 | — | — | Bal. |
| B15 | 20.0 | 0.100 | — | — | — | — | — | 0.520 | — | — | — | 0.005 | 0.001 | Bal. |
| B16 | 22.0 | 0.100 | — | — | — | — | — | — | — | — | — | 0.053 | 0.010 | Bal. |
| B17 | 23.8 | 0.100 | — | — | — | — | — | — | — | — | — | — | — | Bal. |
| B18 | 11.0 | 0.300 | 0.005 | — | — | — | — | — | — | — | — | — | — | Bal. |
| B19 | 12.0 | 0.200 | 1.987 | — | — | — | — | — | — | — | — | — | — | Bal. |
| B20 | 12.0 | 0.204 | — | 0.1 | — | — | — | — | — | — | — | — | — | Bal. |

TABLE 8

| | Component composition of core material (mass %) | | | | | | | | | | | | | |
|---|---|---|---|---|---|---|---|---|---|---|---|---|---|---|
| | | | | | | | | | | | | | | Al + |
| Alloy | | | | | | | | | | | | | | unavoidable |
| No. | Si | Fe | Cu | Mg | Ni | Cr | Mn | Zn | Na | Sr | P | Ti | B | impurities |
| B21 | 12.0 | 0.200 | — | 0.9 | — | — | — | — | — | — | — | — | — | Bal. |
| B22 | 12.0 | 0.203 | — | — | 0.1 | — | — | — | — | — | — | — | — | Bal. |
| B23 | 12.0 | 0.192 | — | — | 2.0 | — | — | — | — | — | — | — | — | Bal. |
| B24 | 12.0 | 0.201 | — | — | — | 0.01 | — | — | — | — | — | — | — | Bal. |
| B25 | 12.0 | 0.203 | — | — | — | 2.00 | — | — | — | — | — | — | — | Bal. |
| B26 | 12.0 | 0.195 | — | — | — | — | 0.01 | — | — | — | — | — | — | Bal. |
| B27 | 12.0 | 0.208 | — | — | — | — | 2.00 | — | — | — | — | — | — | Bal. |
| B28 | 12.0 | 0.204 | — | — | — | — | — | 0.005 | — | — | — | — | — | Bal. |
| B29 | 12.0 | 0.200 | — | — | — | — | — | 1.992 | — | — | — | — | — | Bal. |
| B30 | 12.0 | 0.203 | 1.012 | — | — | — | — | 1.032 | — | — | — | — | — | Bal. |
| B31 | 12.0 | 0.203 | — | 6.0 | — | — | — | 1.003 | — | — | — | — | — | Bal. |
| B32 | 12.0 | 0.201 | — | — | 1.0 | — | — | 1.002 | — | — | — | — | — | Bal. |
| B33 | 12.0 | 0.208 | — | — | — | 1.00 | — | 1.004 | — | — | — | — | — | Bal. |
| B34 | 12.0 | 0.202 | — | — | — | — | 1.00 | 1.008 | — | — | — | — | — | Bal. |
| B35 | 5.8 | 0.203 | 0.305 | 0.3 | 0.3 | 0.10 | 0.11 | — | — | — | — | — | — | Bal. |
| B36 | 18.0 | 0.208 | 1.021 | 0.9 | 1.0 | 1.02 | 1.03 | 1.008 | — | 0.010 | — | — | — | Bal. |
| B37 | 0.6 | 2.901 | — | — | — | — | — | — | — | — | — | — | — | Bal. |
| B38 | 1.2 | 2.890 | — | — | — | — | — | — | — | — | — | — | — | Bal. |
| B39 | 1.7 | 2.780 | — | — | — | — | — | — | — | — | — | — | — | Bal. |
| B40 | 4.8 | 2.521 | — | — | — | — | — | — | — | — | — | — | — | Bal. |
| B41 | 4.5 | 2.700 | 0.320 | 0.3 | 0.3 | 0.10 | 0.10 | — | 0.01 | — | — | — | — | Bal. |
| B42 | 3.8 | 2.890 | 1.008 | 0.9 | 1.0 | 1.02 | 1.01 | 1.001 | — | 0.010 | — | 0.01 | 0.001 | Bal. |
| B43 | 4.0 | 2.760 | — | — | — | — | — | — | — | — | 0.002 | — | — | Bal. |
| BC1 | 0.3 | 0.105 | — | — | — | | | — | — | — | — | — | — | Bal. |
| BC2 | 0.5 | 0.004 | — | — | — | | | — | — | — | — | — | — | Bal. |

TABLE 9

| | Component composition of sheath material (mass %) | | | | | | |
|---|---|---|---|---|---|---|---|
| | | | | | | | Al + |
| | | | | | | | unavoidable |
| Alloy No. | Mg | Cu | Zn | Cr | Fe | Si | impurities |
| C1 | — | 0.001 | 0.001 | 0.001 | 0.281 | 0.003 | Bal. |
| C2 | — | 0.001 | 0.001 | 0.001 | 0.002 | 0.273 | Bal. |
| C3 | 0.3 | 0.020 | 0.590 | 0.284 | 0.022 | 0.007 | Bal. |
| C4 | 0.5 | 0.078 | 0.210 | 0.172 | 0.021 | 0.002 | Bal. |
| C5 | 7.9 | 0.036 | 0.480 | 0.050 | 0.002 | 0.028 | Bal. |
| C6 | 1.2 | 0.057 | 0.120 | 0.055 | 0.020 | 0.021 | Bal |
| C7 | 2.3 | 0.083 | 0.580 | 0.015 | 0.007 | 0.029 | Bal |
| C8 | 3.1 | 0.006 | 0.060 | 0.180 | 0.029 | 0.025 | Bal. |
| C9 | 4.2 | 0.066 | 0.260 | 0.050 | 0.016 | 0.023 | Bal. |
| C10 | 4.4 | 0.123 | 0.500 | 0.100 | 0.002 | 0.012 | Bal. |
| C11 | 5.4 | 0.542 | 0.390 | 0.070 | 0.008 | 0.004 | Bal. |
| C12 | 5.7 | 0.080 | 0.230 | 0.291 | 0.023 | 0.005 | Bal. |
| C13 | 4.3 | 0.125 | 0.160 | 0.030 | 0.020 | 0.002 | Bal. |
| C14 | 4.2 | 0.066 | 0.260 | 0.050 | 0.261 | 0.023 | Bal. |
| C15 | 4.4 | 0.123 | 0.500 | 0.100 | 0.002 | 0.012 | Bal. |
| C16 | 4.2 | 0.057 | 0.120 | 0.055 | 0.020 | 0.021 | Bal. |
| C17 | 4.4 | 0.123 | 0.500 | 0.100 | 0.002 | 0.012 | Bal. |
| C18 | 3.6 | 0.060 | 0.006 | 0.183 | 0.022 | 0.007 | Bal. |
| C19 | 4.2 | 0.123 | 0.280 | 0.212 | 0.017 | 0.007 | Bal. |
| C20 | 4.2 | 0.018 | 0.490 | 0.240 | 0.025 | 0.002 | Bal. |

TABLE 10

| | Component composition of sheath matertial (mass %) | | | | | | |
|---|---|---|---|---|---|---|---|
| | | | | | | | Al + |
| | | | | | | | unavoidable |
| Alloy No. | Mg | Cu | Zn | Cr | Fe | Si | impurities |
| C21 | 4.4 | 0.123 | 0.500 | 0.100 | 0.008 | 0.012 | Bal. |
| C22 | 4.7 | 0.043 | 0.150 | 0.020 | 0.027 | 0.223 | Bal. |
| C23 | 3.9 | 0.088 | 0.280 | 0.190 | 0.020 | 0.020 | Bal. |
| C24 | 4.2 | 0.057 | 0.120 | 0.055 | 0.020 | 0.021 | Bal. |
| C25 | 4.4 | 0.123 | 0.500 | 0.100 | 0.002 | 0.012 | Bal. |
| C26 | 4.2 | 0.057 | 0.120 | 0.055 | 0.020 | 0.021 | Bal. |
| C27 | 3.1 | 0.006 | 0.060 | 0.180 | 0.029 | 0.025 | Bal. |
| C28 | — | 0.532 | 0.007 | 0.001 | 0.032 | 0.003 | Bal. |
| C29 | — | 0.007 | 0.543 | 0.001 | 0.032 | 0.010 | Bal. |
| C30 | 3.1 | 0.142 | 0.230 | 0.100 | 0.016 | 0.029 | Bal. |
| C31 | 4.3 | 0.123 | 0.390 | 0.291 | 0.029 | 0.023 | Bal. |
| C32 | 4.2 | 0.083 | 0.230 | 0.180 | 0.020 | 0.002 | Bal. |
| C33 | 3.1 | 0.006 | 0.060 | 0.180 | 0.029 | 0.025 | Bal. |
| C34 | 4.2 | 0.057 | 0.120 | 0.055 | 0.020 | 0.021 | Bal. |
| C35 | 3.8 | 0.067 | 0.450 | 0.110 | 0.026 | 0.013 | Bal. |
| C36 | 5.9 | 0.043 | 0.440 | 0.183 | 0.017 | 0.020 | Bal. |
| C37 | 3.1 | 0.006 | 0.060 | 0.180 | 0.029 | 0.025 | Bal. |
| C38 | 3.1 | 0.006 | 0.060 | 0.180 | 0.029 | 0.025 | Bal. |
| C39 | 3.1 | 0.006 | 0.060 | 0.180 | 0.029 | 0.025 | Bal. |
| C40 | 3.1 | 0.006 | 0.060 | 0.180 | 0.029 | 0.025 | Bal. |
| C41 | 3.1 | 0.006 | 0.060 | 0.180 | 0.029 | 0.025 | Bal. |
| C42 | 3.1 | 0.006 | 0.060 | 0.180 | 0.029 | 0.025 | Bal. |
| C43 | 3.1 | 0.006 | 0.060 | 0.180 | 0.029 | 0.025 | Bal. |
| CC1 | 5.2 | 0.056 | 0.330 | 0.080 | 0.029 | 0.015 | Bal. |
| CC2 | 3.7 | 0.131 | 0.230 | 0.081 | 0.007 | 0.013 | Bal. |

As listed in Table 11 and Table 12, ingots were produced as ingots for core materials from molten aluminum alloys of alloys Nos. B1 to B7, B11 to B36, BC1, and BC2 by a DC casting method and from molten aluminum alloys of alloys Nos. B8 to B10 by a CC method (step S202-1). Ingots for sheath materials were produced from all the alloys by a DC casting method. For the core materials of the alloys Nos. B1 to B7, B11 to B36, BC1, and BC2, both surfaces of the ingots were faced in 15 mm to make the core materials (step S202-2). For the sheath materials, both surfaces of the ingots were faced in 15 mm, and the ingots were subjected to homogenization treatment in atmospheric air at 520° C. for 6 hours and hot rolled to make hot-rolled sheets having a sheet thickness of 15 mm from alloys Nos. C1 to C7, C11 to C36, CC1, and CC2 and to make hot-rolled sheets having a sheet thickness of 0.5 mm from alloys Nos. C8 to C10. Then, the hot-rolled sheets washed only with caustic soda to make the sheath materials, and the sheath materials were applied to both surfaces of the core materials to make joined materials. Then, the joined materials were subjected to homogenization treatment at 480° C. for 3 hours (step S203). Hot rolling was performed at a rolling start temperature of 460° C. and a rolling end temperature of 340° C. to make hot-rolled sheets having a sheet thickness of 3.0 mm (step S204). The hot-rolled sheets other than the hot-rolled sheets from the alloys of the alloys Nos. B7 and C7 were annealed under conditions of 400° C. and 2 hours and cold rolled (rolling reduction of 66.7%) to have a final sheet thickness of 1.0 mm to make aluminum alloy sheets (step S205). The aluminum alloy sheets were stamped in an annular shape having an outer diameter of 96 mm and an inner diameter of 24 mm to produce disk blanks (step S206).

TABLE 11

| | Core material | | | | Sheath material | | | |
|---|---|---|---|---|---|---|---|---|
| | | Casting conditions | | | | Casting conditions | | |
| | Alloy | | Casting velocity | Ingot sheet | Alloy | | Casting velocity | Ingot sheet |
| | No. | Casting method | (mm/min) | thickness (mm) | No. | Casting method | (mm/min) | thickness (mm) |
| Example 44 | B1 | DC | 30 | 300 | C1 | DC | 30 | 300 |
| Example 45 | B2 | DC | 30 | 300 | C2 | DC | 30 | 300 |
| Example 46 | B3 | DC | 30 | 300 | C3 | DC | 30 | 300 |
| Example 47 | B4 | DC | 30 | 300 | C4 | DC | 30 | 300 |
| Example 48 | B5 | DC | 30 | 300 | C5 | DC | 30 | 300 |
| Example 49 | B6 | DC | 30 | 300 | C6 | DC | 30 | 300 |
| Example 50 | B7 | DC | 30 | 300 | C7 | DC | 30 | 300 |
| Example 51 | B8 | CC | 300 | 9 | C8 | DC | 30 | 300 |
| Example 52 | B9 | CC | 200 | 9 | C9 | DC | 30 | 100 |
| Example 53 | B10 | CC | 100 | 9 | C10 | DC | 30 | 300 |
| Example 54 | B11 | DC | 40 | 300 | C11 | DC | 30 | 300 |
| Example 55 | B12 | DC | 40 | 300 | C12 | DC | 30 | 300 |
| Example 56 | B13 | DC | 40 | 300 | C13 | DC | 30 | 300 |
| Example 57 | B14 | DC | 40 | 300 | C14 | DC | 30 | 300 |
| Example 58 | B15 | DC | 20 | 300 | C15 | DC | 30 | 300 |
| Example 59 | B16 | DC | 20 | 300 | C16 | DC | 30 | 300 |
| Example 60 | B17 | DC | 10 | 300 | C17 | DC | 30 | 300 |
| Example 61 | B18 | DC | 40 | 300 | C18 | DC | 30 | 300 |
| Example 62 | B19 | DC | 40 | 300 | C19 | DC | 30 | 300 |
| Example 63 | B20 | DC | 40 | 300 | C20 | DC | 30 | 300 |

TABLE 12

| | Core material | | | | Sheath material | | | |
|---|---|---|---|---|---|---|---|---|
| | | Casting conditions | | | | Casting conditions | | |
| | Alloy | | Casting velocity | Ingot sheet | Alloy | | Casting velocity | Ingot sheet |
| | No. | Casting method | (mm/min) | thickness (mm) | No. | Casting method | (mm/min) | thickness (mm) |
| Example 64 | B21 | DC | 50 | 300 | C21 | DC | 30 | 300 |
| Example 65 | B22 | DC | 50 | 300 | C22 | DC | 30 | 300 |
| Example 66 | B23 | DC | 50 | 300 | C23 | DC | 30 | 300 |
| Example 67 | B24 | DC | 50 | 300 | C24 | DC | 30 | 300 |
| Example 68 | B25 | DC | 50 | 300 | C25 | DC | 30 | 300 |
| Example 69 | B26 | DC | 50 | 300 | C26 | DC | 30 | 300 |
| Example 70 | B27 | DC | 50 | 300 | C27 | DC | 30 | 300 |
| Example 71 | B28 | DC | 50 | 300 | C28 | DC | 30 | 300 |
| Example 72 | B29 | DC | 60 | 300 | C29 | DC | 30 | 300 |
| Example 73 | B30 | DC | 60 | 300 | C30 | DC | 30 | 300 |
| Example 74 | B31 | DC | 60 | 300 | C31 | DC | 30 | 300 |
| Example 75 | B32 | DC | 60 | 300 | C32 | DC | 30 | 300 |
| Example 76 | B33 | DC | 60 | 300 | C33 | DC | 30 | 300 |
| Example 77 | B34 | DC | 60 | 300 | C34 | DC | 30 | 300 |
| Example 78 | B35 | DC | 60 | 300 | C35 | DC | 30 | 300 |
| Example 79 | B36 | DC | 60 | 300 | C36 | DC | 30 | 300 |
| Example 80 | B37 | DC | 50 | 300 | C37 | DC | 30 | 300 |
| Example 81 | B38 | DC | 50 | 300 | C38 | DC | 30 | 300 |
| Example 82 | B39 | DC | 50 | 300 | C39 | DC | 30 | 300 |
| Example 83 | B40 | DC | 50 | 300 | C40 | DC | 30 | 300 |
| Example 84 | B41 | DC | 50 | 300 | C41 | DC | 30 | 300 |
| Example 85 | B42 | DC | 50 | 300 | C42 | DC | 30 | 300 |
| Example 86 | B43 | DC | 50 | 300 | C43 | DC | 30 | 300 |
| Comparative | BC1 | DC | 30 | 300 | CC1 | DC | 30 | 300 |
| Example 5 | | | | | | | | |
| Comparative | BC2 | DC | 30 | 300 | CC2 | DC | 30 | 300 |
| Example 6 | | | | | | | | |

The disk blank was subjected to pressurization annealing at 400° C. for 3 hours (step S207). The disk blank was subjected to end-surface preparation to have an outer diameter of 95 mm and an inner diameter of 25 mm and was subjected to grinding work (grinding of surface of 10 μm) (step S208). Then, the disk blank was degreased at 60° C. for 5 minutes by AD-68F (manufactured by C. Uyemura & Co., Ltd.), etched at 65° C. for 1 minute by AD-107F (manufactured by C. Uyemura & Co., Ltd.), and further desmutted with 30% HNO₃ aqueous solution (room temperature) for 20 seconds. Double zincate treatment of a surface of the disk blank of which the surface was prepared was performed using AD-301F-3X (manufactured by C. Uyemura & Co., Ltd.) (step S209). The surface subjected to the zincate treatment was electroless plated with Ni—P of 17 μm in thickness using an electroless Ni—P plating treatment liquid (NIMUDEN HDX (manufactured by C. Uyemura & Co., Ltd.)) and then subjected to final polishing (polishing quantity of 4 μm)) by a fabric (step S210).

The ingot after the casting (step S202-1) step, the aluminum alloy sheet after the cold rolling (step S205) step, the aluminum alloy substrate after the grinding work (step S208) step, and the aluminum alloy base after the plating treatment polishing (step S210) step were subjected to the following evaluations.

[Cooling Rate in Casting of Ingot for Core Material]

The DAS of the ingot after the casting (step S202-1) was measured to calculate a cooling rate in the casting. A cross-sectional structure in an ingot thickness direction was observed with an optical microscope, and the DAS was measured by a secondary arm method. The cross section of the center in the thickness direction of the ingot was used for the measurement.

The rigidity, the distributions of the second phase particles having a longest diameter of 3 to 100 μm and a longest diameter of more than 100 μm in the core material, and the smoothness of the plated surface were evaluated by a method similar to the method in the case of the bare material. The above evaluation results are listed in Table 13 and Table 14.

TABLE 13

| | | | | | | | | Distribution of | |
|---|---|---|---|---|---|---|---|---|---|
| | | | | | | | Distribution of | second phase | |
| | | | | | | | second phase | particles | |
| | | | | | Distribution of | | particles | having longest | |
| | | | | | plating pits | | having longest | diameter of | |
| | | | | | having longest | | diameter of 3 | more than 100 μm | |
| | Alloy No. | Alloy No. | Young's | | diameter of 5 μm | | to 100 μm in | in core | Cooling rate in |
| | (core | (sheath | modulus | | or more | Smoothness of | core material | material | casting of core |
| | material) | material) | (GPa) | Rigidity | (pits/mm²) | plated surface | (particles/mm²) | (particles/mm²) | material (° C./s) |
| Example 44 | B1 | C1 | 75 | ⊚ | 0 | ⊚ | 43241 | 0 | 0.4 |
| Example 45 | B2 | C2 | 73 | ◯ | 0 | ⊚ | 88 | 0 | 0.3 |
| Example 46 | B3 | C3 | 75 | ⊚ | 0 | ⊚ | 102 | 0 | 0.5 |
| Example 47 | B4 | C4 | 75 | ⊚ | 0 | ⊚ | 153 | 0 | 0.8 |
| Example 48 | B5 | C5 | 76 | ⊚ | 0 | ⊚ | 655 | 0 | 0.4 |
| Example 49 | B6 | C6 | 78 | ⊚ | 0 | ⊚ | 15036 | 0 | 0.5 |
| Exaglple 50 | B7 | C7 | 78 | ⊚ | 0 | ⊚ | 10058 | 0 | 0.3 |
| Example 51 | B8 | C8 | 81 | ⊚ | 0 | ⊚ | 35059 | 0 | 112.0 |
| Example 52 | B9 | C9 | 75 | ⊚ | 0 | ⊚ | 456 | 0 | 683.0 |
| Example 53 | B10 | C10 | 73 | ◯ | 0 | ⊚ | 78 | 0 | 1056.0 |
| Example 54 | B11 | C11 | 80 | ⊚ | 0 | ⊚ | 34218 | 0 | 0.8 |
| Example 55 | B12 | C12 | 80 | ⊚ | 0 | ⊚ | 37768 | 0 | 0.8 |
| Example 56 | B13 | C13 | 81 | ⊚ | 0 | ⊚ | 38213 | 0 | 0.9 |
| Example 57 | B14 | C14 | 82 | ⊚ | 0 | ⊚ | 39811 | 0 | 0.8 |
| Example 58 | B15 | C15 | 83 | ⊚ | 0 | ⊚ | 42122 | 0 | 0.2 |
| Example 59 | B16 | C16 | 84 | ⊚ | 0 | ⊚ | 48213 | 0 | 0.2 |
| Example 60 | B17 | C17 | 85 | ⊚ | 0 | ⊚ | 52101 | 0 | 0.05 |
| Example 61 | B18 | C18 | 78 | ⊚ | 0 | ⊚ | 11235 | 0 | 0.7 |
| Example 62 | B19 | C19 | 78 | ⊚ | 0 | ⊚ | 25948 | 0 | 0.8 |
| Example 63 | B20 | C20 | 77 | ⊚ | 0 | ⊚ | 15367 | 0 | 0.9 |

TABLE 14

| | | | | | | | Distribution | Distribution of | |
|---|---|---|---|---|---|---|---|---|---|
| | | | | | | | of second | second phase | |
| | | | | | Distribution | | phase particles | particles having | |
| | | | | | of plating | | having longest | longest diameter | Cooling |
| | | | | | pits having | | diameter of | of more | rate in |
| | | | | | longest | | 3 to 100 μm in | than 100 μm in | casting |
| | Alloy No. | Alloy No. | Young's | | diameter of | Smoothness | core material | core material | of core |
| | (core | (sheath | modulus | | 5 μm or more | of plated | (particles/ | (particles/ | material |
| | material) | material) | (GPa) | Rigidity | (pits/mm²) | surface | mm²) | mm²) | (° C./s) |
| Example 64 | B21 | C21 | 78 | ⊚ | 0 | ⊚ | 28746 | 0 | 1.0 |
| Example 65 | B22 | C22 | 77 | ⊚ | 0 | ⊚ | 17506 | 0 | 1.1 |
| Example 66 | B23 | C23 | 78 | ⊚ | 0 | ⊚ | 32145 | 0 | 0.9 |
| Example 67 | B24 | C24 | 77 | ⊚ | 0 | ⊚ | 15438 | 0 | 0.8 |
| Example 68 | B25 | C25 | 78 | ⊚ | 0 | ⊚ | 30324 | 0 | 0.5 |
| Example 69 | B26 | C26 | 76 | ⊚ | 0 | ⊚ | 13323 | 0 | 0.5 |
| Example 70 | B27 | C27 | 77 | ⊚ | 0 | ⊚ | 31872 | 0 | 0.5 |
| Example 71 | B28 | C28 | 78 | ⊚ | 0 | ⊚ | 18213 | 0 | 0.8 |
| Example 72 | B29 | C29 | 78 | ⊚ | 0 | ⊚ | 11202 | 0 | 0.9 |
| Example 73 | B30 | C30 | 79 | ⊚ | 0 | ⊚ | 21271 | 0 | 0.8 |
| Example 74 | B31 | C31 | 79 | ⊚ | 0 | ⊚ | 22192 | 0 | 0.8 |
| Example 75 | B32 | C32 | 78 | ⊚ | 0 | ⊚ | 26813 | 0 | 0.9 |
| Example 76 | B33 | C33 | 77 | ⊚ | 0 | ⊚ | 25436 | 0 | 0.5 |
| Example 77 | B34 | C34 | 78 | ⊚ | 0 | ⊚ | 23758 | 0 | 0.5 |
| Example 78 | B35 | C35 | 76 | ⊚ | 0 | ⊚ | 9249 | 0 | 1.1 |
| Example 79 | B36 | C36 | 81 | ⊚ | 0 | ⊚ | 43210 | 0 | 1.2 |
| Example 80 | B37 | C37 | 72 | ◯ | 0 | ⊚ | 1302 | 0 | 0.8 |
| Example 81 | B38 | C38 | 72 | ◯ | 0 | ⊚ | 1532 | 0 | 0.9 |
| Example 82 | B39 | C39 | 73 | ◯ | 0 | ⊚ | 1921 | 0 | 0.8 |
| Example 83 | B40 | C40 | 74 | ◯ | 0 | ⊚ | 2695 | 0 | 0.8 |
| Example 84 | B41 | C41 | 74 | ◯ | 0 | ⊚ | 3120 | 0 | 0.9 |
| Example 85 | B42 | C42 | 74 | ◯ | 0 | ⊚ | 3129 | 0 | 0.8 |
| Example 86 | B43 | C43 | 74 | ◯ | 0 | ⊚ | 2128 | 0 | 0.9 |
| Comparative | BC1 | CC1 | 69 | X | 0 | ⊚ | 23 | 0 | 0.4 |
| Example 5 | | | | | | | | | |
| Comparative | BC2 | CC2 | 68 | X | 0 | ⊚ | 12 | 0 | 0.5 |
| Example 6 | | | | | | | | | |

As shown in Table 13 and Table 14, the aluminum alloy substrate for a magnetic disk, including a smooth plated surface and having high rigidity, was obtained in each of Example 44 to Example 86. In contrast, each of Comparative Example 5 and Comparative Example 6 was poor in rigidity. Comparative Example 5 resulted in a low Young's modulus and poor rigidity due to the low content of Si. Comparative Example 6 resulted in a low Young's modulus and poor rigidity due to the low content of Fe.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present application is based on Japanese Patent Application No. 2014-223387 filed on Oct. 31, 2014. The specification, claims, and drawings of Japanese Patent Application No. 2014-223387 are incorporated herein by reference in their entirety.

### INDUSTRIAL APPLICABILITY

The present disclosure is preferably used in, for example, a magnetic disk in a storage device for a computer.

1. An aluminum alloy substrate for a magnetic disk, the aluminum alloy substrate comprising:
0.5 mass % or more and 24.0 mass % or less of Si;
0.01 mass % or more and 3.00 mass % or less of Fe; and
a balance of Ai and unavoidable impurities.

2. The aluminum alloy substrate for a magnetic disk according to claim 1, the aluminum alloy substrate further comprising one or more elements selected from the group consisting of:
0.005 mass % or more and 2.000 mass % or less of Cu;
0.1 mass % or more and 6.0 mass % or less of Mg;
0.1 mass % or more and 2.0 mass % or less of Ni;
0.01 mass % or more and 2.00 mass % or less of Cr;
0.01 mass % or more and 2.00 mass % or less of Mn;
0.001 mass % or more and 0.100 mass % or less of Na;
0.001 mass % or more and 0.100 mass % or less of Sr;
0.001 mass % or more and 0.100 mass % or less of P;
0.005 mass % or more and 2.000 mass % or less of Zn; and
Ti and B of which a total of contents is 0.005 mass % or more and 0.500 mass % or less.

3. (canceled)

4. (canceled)

5. The aluminum alloy substrate for a magnetic disk according to claim 1,
wherein second phase particles having a longest diameter of 3 μm or more and 100 μm or less are dispersed at a distribution density of 100 particles/mm² or more and 50000 particles/mm² or less.

6. The aluminum alloy substrate for a magnetic disk according to claim 1, the aluminum alloy substrate comprising second phase particles,
wherein the second phase particles have a longest diameter of 100 μm or less.

7. The aluminum alloy substrate for a magnetic disk according to claim 1,
wherein both surfaces are cladded with a sheath material comprising pure Al or an Al—Mg-based alloy.

8. The aluminum alloy substrate for a magnetic disk according to claim 2,
wherein second phase particles having a longest diameter of 3 μm or more and 100 μm or less are dispersed at a distribution density of 100 particles/mm² or more and 50000 particles/mm² or less.

9. The aluminum alloy substrate for a magnetic disk according to claim 2, the aluminum alloy substrate comprising second phase particles,
wherein the second phase particles have a longest diameter of 100 μm or less.

10. The aluminum alloy substrate for a magnetic disk according claim 2,
wherein both surfaces are cladded with a sheath material comprising pure Al or an Al—Mg-based alloy.
